(19) United States
(12) Patent Application Publication
(10) Pub. No.: US 2024/0306673 A1
(43) Pub. Date: Sep. 19, 2024

(54) READY-TO-DRINK HIGH ACID, COCONUT-BASED COMPOSITION

(71) Applicant: North American Coffee Partnership, Purchase, NY (US)

(72) Inventors: David BELL, Pleasantville, NY (US); Rohil BHATNAGAR, White Plains, NY (US); Pietro CARUSO, New York, NY (US); Manpreet Kaur CHEEMA, Maple Valley, WA (US); Yuan FANG, Cortlandt Manor, NY (US); Gabriela GONZALEZ ISRAEL, Normandy Park, WA (US); Young Paul KIM, Yorktown Heights, NY (US); Eugene SWISHER, Norwalk, CT (US)

(73) Assignee: North American Coffee Partnership, Purchase, NY (US)

(21) Appl. No.: 18/606,813

(22) Filed: Mar. 15, 2024

Related U.S. Application Data
(60) Provisional application No. 63/490,456, filed on Mar. 15, 2023.

(51) Int. Cl. A23L 2/52; A23D 7/005; A23D 7/01; A23D 7/04; A23L 2/38; A23L 29/231; A23L 29/25; A23L 29/269

(52) U.S. Cl. CPC A23L 2/52; A23D 7/0053; A23D 7/011; A23D 7/04; A23L 2/38; A23L 29/231; A23L 29/25; A23L 29/27; A23L 29/272

(57) ABSTRACT

The present disclosure relates to a composition comprising two or more hydrocolloid gums, such a pectin and gellan gum; a coconut-based fatty component, such as coconut cream; and water; in which the composition has a pH less than 7 and is an oil-in-water emulsion. The composition provides a ready-to-drink beverage that is a homogenous emulsion. The present disclosure is further related to a method of preparing the composition, including combining the two or more hydrocolloid gums, the coconut-based fatty component, and water to form a first mixture, blending the first mixture to provide a homogenous first mixture, adding additional water to the homogenous first mixture to provide a second mixture; and blending the second mixture to provide a homogenous second mixture.

### BACKGROUND

High acid beverages containing a fatty coconut component, such as coconut cream, are unstable as evidenced by separation and curdling upon standing. Because of the challenges of a high acid environment, most coconut cream-containing products on the market in the ready-to-drink (RTD) space are provided in a low acid, i.e. higher pH, beverage matrix. While shelf stable coconut-based products can be prepared with coconut water which avoids the complexity arising from protein denaturation, extreme aggregation, and creaming of fat that results from using a fatty coconut component, coconut water typically provides an inferior taste profile, particularly a lack of tartness, which is preferred for fruit juice-containing beverages.

Thus, there is a need for a beverage, such as a ready-to-drink beverage, having a high acid environment and fatty coconut component that is shelf-stable and capable of providing a desired taste profile.

### BRIEF SUMMARY

The present disclosure relates to a composition comprising two or more hydrocolloid gums; a coconut-based fatty component; and water; wherein the composition has a pH less than 7 and is an oil-in-water emulsion.

In some embodiments, the two or more hydrocolloid gums are selected from the group consisting of a plant-based gum, an animal-derived gum, a microbial gum, a seaweed gum, a chemically modified gum, and combinations thereof. In some embodiments, at least one of the two or more hydrocolloid gums is a plant-based gum selected from the group consisting of pectin, sunflower lecithin, guar gum, locust bean gum, tara gum, tamarind gum, linseed gum, gum acacia, karaya gum, tragacanth gum, konjac gum, aloe vera extract, inulin, xanax polysaccharide, and combinations thereof.

In some embodiments, at least one of the two or more hydrocolloid gums is an animal-derived gum selected from the group consisting of gelatin, casein, sodium caseinate, chitin, chitosan, whey protein isolate, whey protein concentrate, collagen, and combinations thereof.

In some embodiments, at least one of the two or more hydrocolloid gums is a microbial gum selected from the group consisting of xanthan gum, gellan gum, coagulated polysaccharide, yeast polysaccharide, and combinations thereof. In some embodiments, at least one of the two or more hydrocolloid gums is a seaweed gum selected from the group consisting of agar, carrageenan, an alginate, and combinations thereof. In some embodiments, at least one of the two or more hydrocolloid gums is a chemically modified gum selected from the group consisting of a cellulose gum, modified starch, sodium polyacrylate, polyvinylpyrrolidone, and combinations thereof.

In some embodiments of the composition, at least one of the two or more hydrocolloid gums is pectin. In some embodiments, the pectin comprises high methoxyl pectin.

In some embodiments of the composition, at least one of the two or more hydrocolloid gums is gellan gum. In some embodiments, the gellan gum comprises high acyl gellan gum.

In some embodiments, the composition comprises two hydrocolloid gums in a weight ratio of about 0.25:1 to about 10:1. In some embodiments, the composition comprises high methoxyl pectin and high acyl gellan gum in a weight ratio of about 3:1 to about 5:1.

In some embodiments, the coconut-based fatty component is coconut cream, coconut milk, coconut milk powder, creamed coconut, coconut oil, or a combination thereof. In some embodiments, the coconut-based fatty component is coconut cream.

In some embodiments, the pH is less than about 5. In some embodiments, the pH is about 4 or less. In any of these embodiments, the pH is about 3 or more.

In some embodiments, the composition further comprises at least one additive. In some embodiments, the at least one additive is selected from the group consisting of green coffee bean extract, white coffee extract, a fruit juice, an acidulant, a pH buffer, a sweetener, a preservative, an antioxidant, a flavoring agent, caffeine, and combinations thereof.

In some embodiments, the composition further comprises green coffee bean extract, white coffee extract, or a combination of both.

In some embodiments, the composition further comprises fruit juice that is white grape juice, strawberry juice, pineapple juice, acai juice, mango juice, dragon fruit juice, starfruit juice, kiwi juice, apple juice, orange juice, pear juice, blueberry juice, blackberry juice, raspberry juice, passionfruit juice, pomegranate juice, watermelon juice, cranberry juice, carrot juice, lemon juice, or a combination thereof.

In some embodiments, the composition further comprises an acidulant comprising at least one organic acid. In some embodiments, the at least one organic acid is citric acid, malic acid, ascorbic acid, fumaric acid, tannic acid, or a combination thereof.

In some embodiments, the composition further comprises a pH buffer that is a citrate buffer, a phosphate buffer, or a combination thereof.

In some embodiments, the composition further comprises a sweetener that is a nutritive sweetener.

In some embodiments, the composition further comprises a preservative that is sodium benzoate, potassium benzoate, potassium sorbate, calcium disodium edetate, or a combination thereof.

In some embodiments, the composition further comprises an antioxidant that is ascorbic acid, a tocopherol, or a combination thereof.

In some embodiments, the composition further comprises a flavoring that is strawberry flavoring agent, pineapple flavoring agent, acai flavoring agent, passionfruit flavoring agent, or a combination thereof.

In some embodiments, the composition has a mean particle size of about 0.3 μm to about 3 μm. In some embodiments, the composition has a mean particle size of about 1.5 μm to about 1.9 μm and d90 from about 2.3 μm to about 2.9 μm.

In some embodiments, the composition has a mean particle size of about 1.3 μm to about 2.3 μm after being stored for 4 days at about 4.4° C. (about 40° F.).

In some embodiments, a mean particle size of the composition at day 0 and a mean particle size of the composition at 4 weeks differs by no more than about 25% after being stored at about 21.1° C. (about 70° F.) for 4 weeks.

In some embodiments, the composition has a pH of about 3.1 to about 3.35 after being stored for 4 days at about 4.4° C. (about 40° F.).

In some embodiments, the composition has a zeta potential from about −5 mV to about −35 mV.

In some embodiments, the composition has a zeta potential from about −14 mV to about −21 mV after being stored for 4 days at about 4.4° C. (about 40° F.).

In some embodiments, a zeta potential of the composition at day 0 and a zeta potential of the composition at 4 weeks differs by no more than about 30% after being stored at about 21.1° C. (about 70° F.) for 4 weeks.

In some embodiments, a sedimentation level of the composition at day 0 and a sedimentation level of the composition at 10 weeks differs by no more than about 2% after being stored at about 21.1° C. (about 70° F.) for 10 weeks.

In some embodiments, a sedimentation level of the composition at day 0 and a sedimentation level of the composition at 24 weeks differs by no more than about 5% after being stored at about 21.1° C. (about 70° F.) for 24 weeks.

In any of the foregoing embodiments, the composition is a ready-to-drink beverage.

The present disclosure further relates to a method of preparing the composition. In some embodiments, the method comprises:
combining the two or more hydrocolloid gums, the coconut-based fatty component (e.g., coconut cream), and water to form a first mixture;
blending the first mixture to provide a homogenous first mixture;
adding additional water to the homogenous first mixture to provide a second mixture; and
blending the second mixture to provide a homogenous second mixture.

In some embodiments, the method further comprises cooling the homogenous first mixture before adding the additional water.

In some embodiments of the method, blending the second mixture to provide a homogenous second mixture takes place in two stages with a pasteurizing step in between the two stages.

In some embodiments of the method, the homogenous second mixture is cooled after blending.

In some embodiments of the method, the two or more hydrocolloid gums are combined first before combining with the coconut-based fatty component and water. In some embodiments, the two or more hydrocolloid gums are combined at about 21° C. to about 74° C. (about 70° F. to about 165° F.).

In some embodiments of the method, the coconut-based fatty component (e.g., coconut cream) is combined with the combined two or more hydrocolloid gums before combining with the water. In some embodiments, the coconut-based fatty component (e.g., coconut cream) is combined with the combined two or more hydrocolloid gums at about 18° C. to about 60° C. (about 65° F. to about 140° F.).

In some embodiments of the method, the water is combined last along with any optional additives.

Additional embodiments and advantages of the disclosure will be set forth, in part, in the description that follows, and will flow from the description, or can be learned by practice of the disclosure.

It is to be understood that both the foregoing summary and the following detailed description are exemplary and explanatory only, and do not restrict the scope of the claims.

### BRIEF DESCRIPTION OF THE DRAWINGS/FIGURES

FIG. 1 is a schematic of a batch process in an embodiment of the production method.

FIG. 2 is a schematic of a general process in an embodiment of the production method.

### DETAILED DESCRIPTION

The headings provided herein are not limitations of the various embodiments of the disclosure, which can be defined by reference to the specification as a whole. It is also to be understood that the terminology used herein is for the purpose of describing particular embodiments only, and is not intended to be limiting, since the scope of the present disclosure will be limited only by the appended claims.

### Definitions

For convenience, the meaning of some terms and phrases used in the specification, examples, and appended claims are provided below. Unless stated otherwise, or implicit from context, the following terms and phrases include the meanings provided below. The definitions are provided to aid in describing particular embodiments, and are not intended to limit the claimed technology, because the scope of the technology is limited only by the claims. Unless otherwise defined, all technical and scientific terms used herein have the same meaning as commonly understood by one of ordinary skill in the art to which this technology belongs. If there is an apparent discrepancy between the usage of a term in the art and its definition provided herein, the definition provided within the specification will control.

The articles “a,” “an,” and “the” are used herein to refer to one or to more than one (i.e., to at least one) of the grammatical object of the article. By way of example, “an element” means one element or more than one element.

As used herein, the term “about” means within an acceptable error range for the particular value as determined by one of ordinary skill in the art, which depends in part on how the value is measured or determined, i.e., the limitations of the measurement system. For example, “about” can mean within 3 or more than 3 standard deviations, per the practice in the art. Alternatively, “about” can mean a range of up to 10% (e.g., up to 5%, or up to 1%) of a given value.

The term “at least” prior to a number or series of numbers is understood to include the number associated with the term “at least,” and all subsequent numbers or integers that could logically be included, as clear from context. When at least is present before a series of numbers or a range, it is understood that “at least” can modify each of the numbers in the series or range. For example, “at least 3” means at least 3, at least 4, at least 5, etc. When at least is present before a component in a method step, then that component is included in the step, whereas additional components are optional.

As used herein, the terms “comprises,” “comprising,” “having,” “including,” “containing,” and the like are open-ended terms meaning “including, but not limited to.” To the extent a given embodiment disclosed herein “comprises” certain elements, it should be understood that present disclosure also specifically contemplates and discloses embodiments that “consist essentially of” those elements and that “consist of” those elements.

As used herein the terms “consists essentially of,” “consisting essentially of,” and the like are to be construed as a semi-closed terms, meaning that no other ingredients which materially affect the basic and novel characteristics of an embodiment are included.

As used herein, the terms “consists of,” “consisting of,” and the like are to be construed as closed terms, such that an embodiment “consisting of” a particular set of elements excludes any element, step, or ingredient not specified in the embodiment.

The phrase “substantially free of” means that a composition contains little or no specified ingredient/component, such as less than about 5 wt %, less than about 4 wt %, less than about 3 wt %, less than about 2 wt %, less than about 1 wt %, less than about 0.5 wt %, less than about 0.3 wt %, less than about 0.2 wt %, less than about 0.1 wt %, or about 0 wt % of the specified ingredient.

As used herein, the term “hydrocolloid gum” refers to a food safe polysaccharide that typically is a hydrophilic, high molecular weight polymer. A hydrocolloid gum dissolves or disperses in hot or cold water to provide a thickening or gelling effect.

As used herein, the term “a coconut-based fatty component” refers to a high fat content product obtained from the fruit of a coconut tree, e.g., Cocos nucifera (L.), more commonly known as a coconut. The coconut-based fatty component can include, e.g., coconut cream, coconut milk, coconut milk powder, creamed coconut, coconut oil, or a combination thereof but does not include coconut water or cream of coconut. Coconut milk can be made by simmering coconut flesh in water. Coconut milk contains about 9-15% fat. Coconut cream can be similarly made using a higher coconut flesh to water ratio (e.g., about 4:1). Coconut cream typically has a fat content of about 19-22%. Coconut milk powder is dehydrated coconut cream that has been processed and spray dried to form a shelf stable powder with a fat content of about 65%. Creamed coconut is also known as coconut butter and is formed from unsweetened, dehydrated coconut flesh that is formed into a semi-solid paste with a fat content of about 81%. Coconut oil is obtained from coconut flesh, typically using either a dry (e.g., pressing) or wet (e.g., extraction with the milk) method. The coconut oil can be unrefined (e.g., cold-pressed) or refined (e.g., refined, bleached, and deodorized (RBD) coconut oil) or be further processed to provide medium-chain triglyceride (MCT) coconut oil. Coconut cream, coconut milk, coconut milk powder, creamed coconut, and coconut oil are readily commercially available and well-known in the art.

### Compositions and Methods of the Disclosure

High acid coconut cream-based beverages typically are prepared and consumed on demand, since the combination of components is unstable for a ready-to-drink format that requires an extended shelf life. The present disclosure is based, at least in part, on the discovery that it is possible to provide a shelf stable, high acid beverage comprising a fatty coconut component, such as coconut cream. The stability properties present in the ready-to-drink beverage described herein were surprisingly found to result from a balance of hydrocolloid gums present in the composition described herein. Accordingly, the present disclosure describes a composition that comprises, consists essentially of, or consists of two or more hydrocolloid gums; a coconut-based fatty component; and water; wherein the composition has a pH less than 7 and is a stable oil-in-water (o/w) emulsion. The present disclosure also describes, among other things, a ready-to-drink beverage and a method of preparing the composition.

In general, the composition can comprise, consist essentially of, or consist of two or more (e.g., 2, 3, 4, etc.) hydrocolloid gums that are from any suitable source. In some embodiments, the two or more hydrocolloid gum can be a plant-based gum, an animal-derived gum, a microbial gum, a seaweed gum, a chemically modified gum, or a combination thereof. In some embodiments, the composition can comprise two or more hydrocolloid gums that are plant-based gums, microbial gums, or a combination of plant-based and microbial gums. In some embodiments, the composition can comprise two hydrocolloid gums. In some embodiments, the composition can comprise three hydrocolloid gums.

In some embodiments, at least one of the two or more hydrocolloid gums can be a plant-based gum selected from the group consisting of pectin, sunflower lecithin, guar gum, locust bean gum, tara gum, tamarind gum, linseed gum, gum acacia (gum Arabic), karaya gum, tragacanth gum, konjac gum, aloe vera extract, inulin, xanax polysaccharide, and combinations thereof.

The pectin can be from any suitable plant source. In some embodiments, the pectin can be selected from the group consisting of apple pectin, pear pectin, beet pectin, citrus pectin (e.g., oranges, grapefruits, lemons, etc.), grape pectin, carrot pectin, and combinations thereof.

In some embodiments, the pectin can have a certain degree of carboxyl groups that are esterified with methanol (e.g., a methoxyl pectin). With fewer than 50% of the carboxyl groups esterified, e.g., less than 50% degree of esterification (DE), the pectin is considered to be low methoxyl pectin. With 50% or greater DE (e.g., 70% DE), the pectin is considered to be high methoxyl pectin. Other types of pectins include, e.g., amidated pectin and thiolated pectin. An example of high methoxyl pectin is GRINDSTED™ Pectin AMD (Danisco, Denmark).

In some embodiments of the composition, at least one of the two or more hydrocolloid gums can be pectin. In some embodiments, the pectin can comprise high methoxyl pectin.

In some embodiments, at least one of the two or more hydrocolloid gums can be an animal-derived gum selected from the group consisting of gelatin, casein, sodium caseinate, chitin, chitosan, whey protein isolate, whey protein concentrate, collagen, and combinations thereof.

In some embodiments, at least one of the two or more hydrocolloid gums can be a microbial gum selected from the group consisting of xanthan gum, gellan gum, coagulated polysaccharide, yeast polysaccharide, and combinations thereof.

Gellan gum typically is divided into two categories: low acyl (<50%) and high acyl (≥50%), depending on the number of acetate groups attached to the polymer backbone. Examples of high acyl gum include, but are not limited to, KELCOGEL™ types: HM-PURE, HM-B, HA-B, and HF-B (CP Kelco, Atlanta, GA).

In some embodiments of the composition, at least one of the two or more hydrocolloid gums can be gellan gum. In some embodiments, the gellan gum can comprise high acyl gellan gum.

In some embodiments, at least one of the two or more hydrocolloid gums can be a seaweed gum selected from the group consisting of agar, carrageenan, an alginate, and combinations thereof. Examples of an alginate include, e.g., sodium alginate, propylene glycol alginate, red algae gum, and brown algae salt alginate.

In some embodiments, at least one of the two or more hydrocolloid gums can be a chemically modified gum selected from the group consisting of a cellulose gum, modified starch, sodium polyacrylate (PAAS), polyvinylpyrrolidone (PVP, also known as povidone), and combinations thereof. Examples of a cellulose gum include, e.g., sodium carboxymethyl cellulose, hydroxyethyl cellulose, microcrystalline cellulose, methylcellulose, hydroxypropyl methylcellulose, and hydroxypropyl cellulose. Examples of a modified starch include, e.g., pregelatinized starch, acid-treated starch, oxidized starch, starch acetate, hydroxypropylated starch, and carboxymethylated starch.

In some embodiments, the composition can comprise two or more hydrocolloid gums selected from pectin, gellan gum, gum acacia (gum Arabic), sunflower lecithin, xanthan gum, and combinations thereof. Combinations include, for example, pectin/gellan gum/gum acacia, pectin/gellan gum/sunflower lecithin, pectin/gellan gum, pectin/gum acacia, and pectin/xanthan gum. In some embodiments, the composition can comprise pectin and gellan gum, including high methoxyl pectin and high acyl gellan gum.

In some embodiments, each hydrocolloid gum has a suitable number average molecular weight (Mn) of about 1,000 g/mol or more. In such embodiments, each hydrocolloid gum can have any suitable number average molecular weight, such as about 1,000 g/mol or more to about 40,000,000 g/mol or less. In some embodiments, each of the hydrocolloid gums can have a number average molecular weight ranging from about 1,000 g/mol or more (e.g., about 2000 g/mol or more, about 4000 g/mol or more, about 6000 g/mol or more, about 8000 g/mol or more, about 10,000 g/mol or more, about 20,000 g/mol or more, about 30,000 g/mol or more, about 40,000 g/mol or more, about 50,000 g/mol or more, about 60,000 g/mol or more, about 80,000 g/mol or more, about 100,000 g/mol or more, about 150,000 g/mol or more, about 200,000 g/mol or more, about 250,000 g/mol or more, about 300,000 g/mol or more, about 350,000 g/mol or more, about 400,000 g/mol or more, about 450,000 g/mol or more, about 500,000 g/mol or more, about 550,000 g/mol or more, about 600,000 g/mol or more, about 650,000 g/mol or more, about 700,000 g/mol or more, about 750,000 g/mol or more, about 800,000 g/mol or more, about 850,000 g/mol or more, about 900,000 g/mol or more, about 1,000,000 g/mol or more, about 1,500,000 g/mol or more, about 2,000,000 g/mol or more, about 2,500,000 g/mol or more, about 3,000,000 g/mol or more, about 3,500,000 g/mol or more, about 4,000,000 g/mol or more, about 4,500,000 g/mol or more, about 5,000,000 g/mol or more, about 6,000,000 g/mol or more, about 7,000,000 g/mol or more, about 8,000,000 g/mol or more, about 9,000,000 g/mol or more, about 10,000,000 g/mol or more, about 15,000,000 g/mol or more, about 20,000,000 g/mol or more, about 25,000,000 g/mol or more, about 30,000,000 g/mol or more, or about 35,000,000 g/mol or more) to about 40,000,000 g/mol or less (e.g., about 35,000,000 g/mol or less, about 30,000,000 g/mol or less, about 25,000,000 g/mol or less, about 20,000,000 g/mol or less, about 15,000,000 g/mol or less, about 10,000,000 g/mol or less, about 9,000,000 g/mol or less, about 8,000,000 g/mol or less, about 7,000,000 g/mol or less, about 6,000,000 g/mol or less, about 5,000,000 g/mol or less, about 4,000,000 g/mol or less, about 3,000,000 g/mol or less, about 2,000,000 g/mol or less, about 1,000,000 g/mol or less, about 900,000 g/mol or less, about 850,000 g/mol or less, about 800,000 g/mol or less, about 750,000 g/mol or less, about 700,000 g/mol or less, about 650,000 g/mol or less, about 600,000 g/mol or less, about 550,000 g/mol or less, about 500,000 g/mol or less, about 450,000 g/mol or less, about 400,000 g/mol or less, about 350,000 g/mol or less, about 300,000 g/mol or less, about 250,000 g/mol or less, about 200,000 g/mol or less, about 150,000 g/mol or less, about 100,000 g/mol or less, about 80,000 g/mol or less, about 60,000 g/mol or less, about 50,000 g/mol or less, about 40,000 g/mol or less, about 30,000 g/mol or less, about 20,000 g/mol or less, about 10,000 g/mol or less, about 8,000 g/mol or less, about 6,000 g/mol or less, about 4,000 g/mol or less, or about 2,000 g/mol or less).

In some embodiments, each of the hydrocolloid gums can have a number average molecular weight of about 100,000 g/mol to about 40,000,000 g/mol, about 100,000 g/mol to about 35,000,000 g/mol or about 500,000 g/mol to about 10,000,000 g/mol or about 100,000 g/mol to about 2,000,000 g/mol or about 50,000 g/mol to about 1,000,000 g/mol or about 50,000 g/mol to about 500,000 g/mol or about 50,000 g/mol to about 2500,000 g/mol or about 100,000 g/mol to about 200,000 g/mol. In some embodiments, the composition can comprise pectin (e.g., high methoxyl pectin) with a number average molecular weight ranging from about 100,000 to about 200,000 g/mol or about 110,000 to about 150,000 g/mol. Alternatively or in combination, in some embodiments, the composition can comprise gellan gum (e.g., high acyl gellan gum) with a number average molecular weight ranging from about 50,000 to about 2,000,000 g/mol or about 1,000,000 to about 2,000,000 g/mol.

Without wishing to be bound by any theory, it is believed that the two or more hydrocolloid gums, as described herein, work synergistically together with the coconut-based fatty component to provide a stable o/w emulsion, compared to the same composition comprising only one such hydrocolloid gum.

The two or more hydrocolloid gums can be present in the composition in any suitable amount. For example, each hydrocolloid gum can be present in a range from about 0.01% to about 3% by weight (pbw, which is the same as wt %) of the composition, including about 0.01 pbw or more (e.g., about 0.02 pbw or more, about 0.03 pbw or more, about 0.04 pbw or more, about 0.05 pbw or more, about 0.06 pbw or more, about 0.07 pbw or more, about 0.08 pbw or more, about 0.09 pbw or more, about 0.1 pbw or more, about 0.2 pbw or more, about 0.3 pbw or more, about 0.4 pbw or more, about 0.5 pbw or more, about 0.6 pbw or more, about 0.7 pbw or more, about 0.8 pbw or more, about 0.9 pbw or more, about 1 pbw or more, about 1.1 pbw or more, about 1.2 pbw or more, about 1.4 pbw or more, about 1.6 pbw or more, about 1.8 pbw or more, about 2 pbw or more, about 2.2 pbw or more, about 2.4 pbw or more, about 2.6 pbw or more, or about 2.8 pbw or more) up to about 3 pbw (e.g., about 2.8 pbw or less, about 2.6 pbw or less, about 2.4 pbw or less, about 2.2 pbw or less, about 2 pbw or less, about 1.8 pbw or less, about 1.6 pbw or less, about 1.4 pbw or less, about 1.2 pbw or less, about 1 pbw or less, about 0.9 pbw or less, about 0.8 pbw or less, about 0.7 pbw or less, about 0.6 pbw or less, about 0.5 pbw or less, about 0.4 pbw or less, about 0.3 pbw or less, about 0.2 pbw or less, about 0.1 pbw or less, about 0.09 pbw or less, about 0.08 pbw or less, about 0.07 pbw or less, about 0.06 pbw or less, about 0.05 pbw or less, about 0.04 pbw or less, about 0.03 pbw or less, or about 0.02 pbw or less). In some embodiments, each hydrocolloid gum can be present in an amount of about 0.03 to about 1 pbw or about 0.05 to about 0.8 pbw, or about 0.08 to about 0.6 pbw.

In some embodiments, the total concentration of the hydrocolloid gums in the composition can be about 0.02 to about 6 pbw (e.g., about 0.03 to about 2 pbw, about 0.05 to about 1 pbw, about 0.1 to about 1 pbw, about 0.3 to about 1 pbw, or about 0.3 to about 0.8 pbw).

In some embodiments of the composition, it was discovered that a hydrocolloid gum that is stable at a lower pH (e.g., pH<about 4) and increases viscosity and adds opacity to the composition can be present in a higher concentration than a hydrocolloid gum that creates a weaker gel matrix that prevents sedimentation. In some embodiments, a hydrocolloid gum that creates a weaker gel matrix that prevents sedimentation is stable at pH>4.

In some embodiments, the composition comprises two hydrocolloid gums in a weight ratio (e.g., hydrocolloid gum stable at pH<about 4 to hydrocolloid gum stable at pH>4) of about 0.25:1 to about 10:1, which includes ratios of about 0.25:1, about 0.5:1, about 0.75:1, about 1:1, about 1.5:1, about 2:1, about 2.5:1, about 3:1, about 3.5:1, about 4:1, about 4.5:1, about 5:1, about 5.5:1, about 6:1, about 6.5:1, about 7:1, about 7.5:1, about 8:1, about 8.5:1, about 9:1, about 9.5:1, or about 10:1. In some embodiments, the weight ratio of one hydrocolloid gum to the second hydrocolloid gum can be within a range of about 1:1 to about 8:1 (e.g., about 3:1 to about 7:1, about 4:1 to about 8:1, about 4:1 to about 7:1, or about 4:1 to about 5:1). In some embodiments, the weight ratio range is for pectin:second gum, such as pectin:gellan gum. In some embodiments, the composition can comprise high methoxyl pectin and high acyl gellan gum in a weight ratio of about 3:1 to about 5:1.

The composition comprises a coconut-based fatty component, which is any suitable product obtained from a coconut, as described herein, and with a high (e.g., about 9-80%, about 15-80%, about 15-65%, or about 15-24%) fat content. In some embodiments, the coconut-based fatty component in the composition can be coconut cream, coconut milk, coconut milk powder, creamed coconut, coconut oil, or a combination thereof. In some embodiments, the coconut-based fatty component can be coconut cream.

In some embodiments, the composition is substantially free of coconut water.

In some embodiments, the composition can comprise a milk alternative (e.g., a dairy-free milk) in addition to or in place of the coconut-based fatty component. For example, the milk alternative can be a plant-based milk, which includes, e.g., a nut-based milk, a vegetable-based milk, a legume-based milk, a seed-based milk, a cereal-based milk, or a pseudo-cereal-based milk. Examples of a nut-based milk include, e.g., milk obtained from almonds, cashews, hazelnuts, macadamias, walnuts, and Brazil nuts. Examples of a vegetable-based milk include, e.g., milk obtained from potatoes, peas, or tiger nuts. Examples of a legume-based milk include, e.g., milk obtained from soybeans, peanuts, lupin beans, or cowpeas (black-eyed peas). Examples of a seed-based milk include, e.g., milk obtained from sesame seeds, flax seed, hemp, sunflower seeds, or chia seeds. Examples of a cereal-based milk include, e.g., milk obtained from oats, rice, corn, or spelt. Examples of a pseudo-cereal-based milk include, e.g., milk obtained from quinoa.

The coconut-based fatty component or milk alternative can be present in the composition in any suitable amount. For example, the coconut-based fatty component or milk alternative can be present in a range from about 0.1 pbw to about 5 pbw of the composition, including about 0.1 pbw or more (e.g., about 0.2 pbw or more, about 0.3 pbw or more, about 0.4 pbw or more, about 0.5 pbw or more, about 0.8 pbw or more, about 1 pbw or more, about 1.2 pbw or more, about 1.3 pbw or more, about 1.4 pbw or more, about 1.5 pbw or more, about 1.8 pbw or more, about 2.0 pbw or more, about 2.2 pbw or more, about 2.4 pbw or more, about 2.6 pbw or more, about 2.8 pbw or more, about 3 pbw or more, about 3.2 pbw or more, about 3.4 pbw or more, about 3.6 pbw or more, or about 3.8 pbw or more, about 4 pbw or more, about 4.2 pbw or more, about 4.4 pbw or more, about 4.6 pbw or more, or about 4.8 pbw or more) up to about 5 pbw (e.g., about 4.5 pbw or less, about 4 pbw or less, about 3.5 pbw or less, about 3 pbw or less, about 2.5 pbw or less, about 2 pbw or less, about 1.5 pbw or less, about 1 pbw or less, about 0.8 pbw or less, about 0.6 pbw or less, about 0.4 pbw or less, or about 0.2 pbw or less).

In some embodiments, the composition can comprise pectin, gellan gum, and coconut cream, including high methoxyl pectin, high acyl gellan gum, and coconut cream.

The composition has a high acid matrix such that the composition has a pH less than

7. In some embodiments, the pH can be less than about 6 or less than about 5. In some embodiments, the pH can be about 4 or less. In any of these embodiments, the lower end of the pH range can be about 3. Thus, in some embodiments, the composition can have a pH range of about 3 or more and about 6 or less (e.g., about 3 to about 5 or about 3 to about 4). The pH can be adjusted with any suitable component or additive. For example, some hydrocolloid gums (e.g., pectin) can be acidic in nature. Similarly, many fruit juices are acidic. If necessary, one or more acidulants, a pH buffer, or both, such those described herein, can be added.

In some embodiments, the composition can have a pH of about 3.1 to about 3.35 after being stored for 4 days at about 4.4° C. (about 40° F.).

In some embodiments, the composition or a ready-to-drink beverage prepared from the composition can further comprise at least one (e.g., 1, 2, 3, 4, 5, 6, 7, 8, etc.) additive. In some embodiments, the additive can be selected from the group consisting of green coffee bean extract, white coffee extract, a fruit juice, an acidulant, a pH buffer, a sweetener, a preservative, an antioxidant, a flavoring agent, caffeine, and combinations thereof. In some embodiments, additives that do not have a material effect, such as a colorant, can be included in the composition.

In some embodiments, the composition can further comprise green coffee bean extract, white coffee extract, or a combination of both. The green coffee bean extract and white coffee extract can be caffeinated or decaffeinated.

The composition can include green coffee bean extract or white coffee extract in any suitable amount, including in a range from about 0.01 pbw to about 0.25 pbw of the composition, including about 0.01 pbw or more (e.g., about 0.02 pbw or more, about 0.03 pbw or more, about 0.04 pbw or more, about 0.05 pbw or more, about 0.08 pbw or more, about 0.1 pbw or more, about 0.15 pbw or more, or about 0.2 pbw or more) up to about 0.25 pbw (e.g., about 0.2 pbw or less, about 0.15 pbw or less, about 0.1 pbw or less, about 0.08 pbw or less, about 0.07 pbw or less, about 0.06 pbw or less, about 0.05 pbw or less, about 0.04 pbw or less, about 0.03 pbw or less, or about 0.02 pbw or less). In some embodiments, the green coffee bean extract or white coffee extract is present in an amount of about 0.1 pbw to about 0.02 pbw.

In some embodiments, the composition can further comprise at least one (e.g., 1, 2, 3, 4, etc.) fruit juice. The fruit juice can be a concentrate or not from concentrate and either filtered or unfiltered. In some embodiments, the at least one fruit juice can be a filtered concentrate. Non-limiting examples of juice include, e.g., white grape juice, strawberry juice, pineapple juice, acai juice, mango juice, dragon fruit juice, starfruit juice, kiwi juice, apple juice, orange juice, pear juice, blueberry juice, blackberry juice, raspberry juice, passionfruit juice, pomegranate juice, watermelon juice, cranberry juice, carrot juice, lemon juice, or a combination thereof. In some embodiments, a combination of fruit juices (e.g., a combination of fruit juice concentrates) can be used.

The composition can include at least one fruit juice in any suitable amount. For example, each fruit juice (e.g., a fruit juice concentrate) can be present in a range from about 0.1 pbw to about 10 pbw of the composition, including about 0.1 pbw or more (e.g., about 0.2 pbw or more, about 0.3 pbw or more, about 0.4 pbw or more, about 0.5 pbw or more, about 0.8 pbw or more, about 1 pbw or more, about 1.2 pbw or more, about 1.3 pbw or more, about 1.4 pbw or more, about 1.5 pbw or more, about 1.8 pbw or more, about 2.0 pbw or more, about 2.2 pbw or more, about 2.4 pbw or more, about 2.6 pbw or more, about 2.8 pbw or more, about 3 pbw or more, about 3.2 pbw or more, about 3.4 pbw or more, about 3.6 pbw or more, or about 3.8 pbw or more, about 4 pbw or more, about 4.2 pbw or more, about 4.4 pbw or more, about 4.6 pbw or more, about 4.8 pbw or more, about 5 pbw or more, about 5.2 pbw or more, about 5.4 pbw or more, about 5.6 pbw or more, about 5.8 pbw or more, about 6 pbw or more, about 6.2 pbw or more, about 6.4 pbw or more, about 6.6 pbw or more, about 6.8 pbw or more, about 7 pbw or more, about 7.2 pbw or more, about 7.4 pbw or more, about 7.6 pbw or more, about 7.8 pbw or more, about 8 pbw or more, about 8.2 pbw or more, about 8.4 pbw or more, about 8.6 pbw or more, about 8.8 pbw or more, about 9 pbw or more, about 9.2 pbw or more, about 9.4 pbw or more, about 9.6 pbw or more, or about 9.8 pbw or more,) up to about 10 pbw (e.g., about 9.5 pbw or less, about 9 pbw or less, about 8.5 pbw or less, about 8 pbw or less, about 7.5 pbw or less, about 7 pbw or less, about 6.5 pbw or less, about 6 pbw or less, about 5.5 pbw or less, about 5 pbw or less, about 4.5 pbw or less, about 4 pbw or less, about 3.5 pbw or less, about 3 pbw or less, about 2.5 pbw or less, about 2 pbw or less, about 1.5 pbw or less, about 1 pbw or less, about 0.8 pbw or less, about 0.6 pbw or less, about 0.4 pbw or less, or about 0.2 pbw or less).

In some embodiments, the total (combined) amount of fruit juice (e.g., combined fruit juice concentrates) can be present in a range from about 0.1 pbw to about 10 pbw of the composition, including about 0.1 pbw or more (e.g., about 0.2 pbw or more, about 0.3 pbw or more, about 0.4 pbw or more, about 0.5 pbw or more, about 0.8 pbw or more, about 1 pbw or more, about 1.2 pbw or more, about 1.3 pbw or more, about 1.4 pbw or more, about 1.5 pbw or more, about 1.8 pbw or more, about 2.0 pbw or more, about 2.2 pbw or more, about 2.4 pbw or more, about 2.6 pbw or more, about 2.8 pbw or more, about 3 pbw or more, about 3.2 pbw or more, about 3.4 pbw or more, about 3.6 pbw or more, or about 3.8 pbw or more, about 4 pbw or more, about 4.2 pbw or more, about 4.4 pbw or more, about 4.6 pbw or more, about 4.8 pbw or more, about 5 pbw or more, about 5.2 pbw or more, about 5.4 pbw or more, about 5.6 pbw or more, about 5.8 pbw or more, about 6 pbw or more, about 6.2 pbw or more, about 6.4 pbw or more, about 6.6 pbw or more, about 6.8 pbw or more, about 7 pbw or more, about 7.2 pbw or more, about 7.4 pbw or more, about 7.6 pbw or more, about 7.8 pbw or more, about 8 pbw or more, about 8.2 pbw or more, about 8.4 pbw or more, about 8.6 pbw or more, about 8.8 pbw or more, about 9 pbw or more, about 9.2 pbw or more, about 9.4 pbw or more, about 9.6 pbw or more, or about 9.8 pbw or more) up to about 10 pbw (e.g., about 9.5 pbw or less, about 9 pbw or less, about 8.5 pbw or less, about 8 pbw or less, about 7.5 pbw or less, about 7 pbw or less, about 6.5 pbw or less, about 6 pbw or less, about 5.5 pbw or less, about 5 pbw or less, about 4.5 pbw or less, about 4 pbw or less, about 3.5 pbw or less, about 3 pbw or less, about 2.5 pbw or less, about 2 pbw or less, about 1.5 pbw or less, about 1 pbw or less, about 0.8 pbw or less, about 0.6 pbw or less, about 0.4 pbw or less, or about 0.2 pbw or less).

In some embodiments, the composition can further comprise a food safe acidulant. In some embodiments, the acidulant can comprise phosphoric acid. In some embodiments, the acidulant can comprise at least one (e.g., 1, 2, 3, 4, etc.) organic acid, such as citric acid, malic acid, maleic acid, gluconic acid, tartaric acid, fumaric acid, lactic acid, alginic acid, ascorbic acid, adipic acid, or a combination thereof. In some embodiments, the at least one organic acid can be citric acid, malic acid, ascorbic acid, fumaric acid, tannic acid, or a combination thereof. In some embodiments, the composition can comprise a combination of citric acid, ascorbic acid, and malic acid.

The composition can include at least one acidulant in any suitable amount. For example, each acidulant (e.g., citric acid) can be present in a range from about 0.01 pbw to about 0.3 pbw of the composition, including about 0.01 pbw or more (e.g., about 0.02 pbw or more, about 0.03 pbw or more, about 0.04 pbw or more, about 0.05 pbw or more, about 0.08 pbw or more, about 0.1 pbw or more, about 0.15 pbw or more, about 0.2 pbw or more, or about 0.25 pbw or more) up to about 0.3 pbw (e.g., about 0.25 pbw or less, about 0.2 pbw or less, about 0.15 pbw or less, about 0.1 pbw or less, about 0.08 pbw or less, about 0.07 pbw or less, about 0.06 pbw or less, about 0.05 pbw or less, about 0.04 pbw or less, about 0.03 pbw or less, or about 0.02 pbw or less). In some embodiments, each acidulant is present from about 0.01 to about 0.1 pbw.

In some embodiments, the total (combined) amount of acidulants (e.g., citric acid, ascorbic acid, and malic acid) can be present in a range from about 0.03 pbw to about 0.5 pbw of the composition, including about 0.03 pbw or more (e.g., about 0.04 pbw or more, about 0.05 pbw or more, about 0.08 pbw or more, about 0.1 pbw or more, about 0.15 pbw or more, about 0.2 pbw or more, about 0.25 pbw or more, about 0.3 pbw or more, about 0.35 pbw or more, about 0.4 pbw or more, or about 0.45 pbw or more) up to about 0.5 pbw (e.g., about 0.45 pbw or less, about 0.4 pbw or less, about 0.35 pbw or less, about 0.3 pbw or less, about 0.25 pbw or less, about 0.2 pbw or less, about 0.15 pbw or less, about 0.1 pbw or less, about 0.08 pbw or less, about 0.07 pbw or less, about 0.06 pbw or less, about 0.05 pbw or less, or about 0.04 pbw or less).

In some embodiments, the composition can further comprise a sweetener. In some embodiments, the sweetener can be a nutritive sweetener, a non-nutritive sweetener, or a combination of both. Typical nutritive sweeteners include, e.g., sugar (i.e., sucrose), dextrose, fructose, high fructose corn syrup, and combinations thereof. In some embodiments, the sweetener can be sucrose.

In some embodiments, an added sweetener is not needed such that the concentration of an added sweetener is 0 pbw. In other embodiments, the sweetener (e.g., sucrose) can be present in a range from about 0.1 pbw to about 10 pbw of the composition, including about 0.1 pbw or more (e.g., about 0.2 pbw or more, about 0.3 pbw or more, about 0.4 pbw or more, about 0.5 pbw or more, about 0.8 pbw or more, about 1 pbw or more, about 1.2 pbw or more, about 1.3 pbw or more, about 1.4 pbw or more, about 1.5 pbw or more, about 1.8 pbw or more, about 2.0 pbw or more, about 2.2 pbw or more, about 2.4 pbw or more, about 2.6 pbw or more, about 2.8 pbw or more, about 3 pbw or more, about 3.2 pbw or more, about 3.4 pbw or more, about 3.6 pbw or more, or about 3.8 pbw or more, about 4 pbw or more, about 4.2 pbw or more, about 4.4 pbw or more, about 4.6 pbw or more, about 4.8 pbw or more, about 5 pbw or more, about 5.2 pbw or more, about 5.4 pbw or more, about 5.6 pbw or more, about 5.8 pbw or more, about 6 pbw or more, about 6.2 pbw or more, about 6.4 pbw or more, about 6.6 pbw or more, about 6.8 pbw or more, about 7 pbw or more, about 7.2 pbw or more, about 7.4 pbw or more, about 7.6 pbw or more, about 7.8 pbw or more, about 8 pbw or more, about 8.2 pbw or more, about 8.4 pbw or more, about 8.6 pbw or more, about 8.8 pbw or more, about 9 pbw or more, about 9.2 pbw or more, about 9.4 pbw or more, about 9.6 pbw or more, or about 9.8 pbw or more) up to about 10 pbw (e.g., about 9.5 pbw or less, about 9 pbw or less, about 8.5 pbw or less, about 8 pbw or less, about 7.5 pbw or less, about 7 pbw or less, about 6.5 pbw or less, about 6 pbw or less, about 5.5 pbw or less, about 5 pbw or less, about 4.5 pbw or less, about 4 pbw or less, about 3.5 pbw or less, about 3 pbw or less, about 2.5 pbw or less, about 2 pbw or less, about 1.5 pbw or less, about 1 pbw or less, about 0.8 pbw or less, about 0.6 pbw or less, about 0.4 pbw or less, or about 0.2 pbw or less).

In some embodiments, the composition can further comprise a pH buffer. In some embodiments, the pH buffer can be any food grade buffer that controls the pH to be within a desired range. In some embodiments, the pH buffer can be a citrate buffer, a phosphate buffer, or a combination thereof, including Group I or II citrate and phosphate salts (e.g., sodium citrate, sodium phosphate, potassium citrate, potassium phosphate).

In some embodiments, the composition can further comprise at least one (e.g., 1, 2, 3, 4, etc.) preservative. In some embodiments, the preservative can be sodium benzoate, potassium benzoate, calcium propionate, potassium sorbate, sodium sorbate, calcium disodium edetate, a sodium polyphosphate (e.g., sodium acid polyphosphate, sodium hexamethaphosphate, sodium tripolyphosphate, tetrasodium pyrophosphate, or sodium trimetaphosphate), or a combination thereof.

In some embodiments, the composition can further comprise an antioxidant. In some embodiments, the antioxidant can be a vitamin (e.g., ascorbic acid, a tocopherol), a polyphenol (e.g., a flavonoid, phenolic acid, lignin, or a stilbene), or a combination thereof. Vitamin E is a group of eight fat soluble compounds that include four tocopherols (i.e., α-tocopherol, β-tocopherol, γ-tocopherol, and δ-tocopherol) and four tocotrienols (i.e., α-tocotrienol, β-tocotrienol, γ-tocotrienol, and δ-tocotrienol).

In some embodiments, the composition can further comprise at least one (e.g., 1, 2, 3, 4, etc.) flavoring agent. The flavoring agent can be any compatible food safe agent used for flavoring foods or beverages. The flavoring agent can be natural or synthetic. Non-limiting examples include, e.g., for example, a citrus flavor (e.g., limonene, octanal), a vanilla flavor (e.g., vanilla extract, vanillin), a cinnamon flavor (e.g., cinnamic acid), a fruit flavor (e.g., cherry, raspberry, strawberry, grape, strawberry, pineapple, passionfruit), and combinations thereof. In some embodiments, the composition further comprises a flavoring that is strawberry flavoring agent, pineapple flavoring agent, acai flavoring agent, passionfruit flavoring agent, or a combination thereof.

For the pH buffer, preservative, antioxidant, flavoring agent, and caffeine, each additive can be present in a range from about 0.01 pbw to about 5 pbw of the composition, including about 0.01 pbw or more (e.g., about 0.02 pbw or more, about 0.03 pbw or more, about 0.04 pbw or more, about 0.05 pbw or more, about 0.08 pbw or more, about 0.1 pbw or more, about 0.2 pbw or more, about 0.3 pbw or more, about 0.4 pbw or more, about 0.5 pbw or more, about 0.8 pbw or more, about 1 pbw or more, about 1.2 pbw or more, about 1.3 pbw or more, about 1.4 pbw or more, about 1.5 pbw or more, about 1.8 pbw or more, about 2.0 pbw or more, about 2.2 pbw or more, about 2.4 pbw or more, about 2.6 pbw or more, about 2.8 pbw or more, about 3 pbw or more, about 3.2 pbw or more, about 3.4 pbw or more, about 3.6 pbw or more, or about 3.8 pbw or more, about 4 pbw or more, about 4.2 pbw or more, about 4.4 pbw or more, about 4.6 pbw or more, or about 4.8 pbw or more) up to about 5 pbw (e.g., about 4.5 pbw or less, about 4 pbw or less, about 3.5 pbw or less, about 3 pbw or less, about 2.5 pbw or less, about 2 pbw or less, about 1.5 pbw or less, about 1 pbw or less, about 0.8 pbw or less, about 0.6 pbw or less, about 0.4 pbw or less, about 0.2 pbw or less, about 0.1 pbw or less, about 0.08 pbw or less, about 0.05 pbw or less, about 0.04 pbw or less, about 0.03 pbw or less, or about 0.02 pbw or less).

The composition is an oil-in-water (o/w) emulsion, such that the oil, e.g. the coconut-based fatty component, is the dispersed phase distributed in the continuous water phase. It was surprisingly discovered that the coconut-based fatty component could be stabilized (e.g., a reduction in separation, curdling, and/or sedimentation) in a high acid matrix in the presence of two or more hydrocolloid gums. Thus, in some embodiments, the composition can be a homogeneous composition.

In some embodiments, the composition can have a viscosity that is about 3 cP to about 30 cP. In some embodiments, the composition can have a viscosity that is about 3 cP to about 25 cP, including about 5 cP to about 20 cP, about 5 cP to about 15 cP, or about 5 cP to about 12 cP. In some embodiments, the composition can have a viscosity that is about 5 cP to about 12 cP. Viscosity can be measured using any suitable technique, including using a Brookfield viscometer with UL adapter, spindle 0 at 60 rpm, and at room temperature.

In some embodiments, the stability of the o/w emulsion can be measured by the mean particle size (MPS). For example, in some embodiments, a stable composition can have a mean particle size of about 0.3 μm (e.g., about 0.4 μm or more, about 0.5 μm or more, about 0.6 μm or more, about 0.7 μm or more, about 0.8 μm or more, about 0.9 μm or more, about 1 μm or more, about 1.1 μm or more, about 1.2 μm or more, about 1.3 μm or more, about 1.4 μm or more, about 1.5 μm or more, about 1.6 μm or more, about 1.7 μm or more, about 1.8 μm or more, about 1.9 μm or more, about 2 μm or more, about 2.1 μm or more, about 2.2 μm or more, about 2.3 μm or more, about 2.4 μm or more, about 2.5 μm or more, about 2.6 μm or more, about 2.7 μm or more, about 2.8 μm or more, or about 2.9 μm or more) to about 3 μm (e.g., about 2.9 μm or less, about 2.8 μm or less, about 2.7 μm or less, about 2.6 μm or less, about 2.5 μm or less, about 2.4 μm or less, about 2.3 μm or less, about 2.2 μm or less, about 2.1 μm or less, about 2 μm or less, about 1.9 μm or less, about 1.8 μm or less, about 1.7 μm or less, about 1.6 μm or less, about 1.5 μm or less, about 1.4 μm or less, about 1.3 μm or less, about 1.2 μm or less, about 1.1 μm or less, about 1 μm or less, about 0.9 μm or less, about 0.8 μm or less, about 0.7 μm or less, about 0.6 μm or less, about 0.5 μm or less, or about 0.4 μm or less).

In some embodiments, the particle size distribution ranges from about 0.1 μm to about 3 μm. In other embodiments, the particle size distribution ranges from about 1.5 μm to about 2 μm.

In some embodiments, a stable composition can have a mean particle size of about 1.5 μm to about 1.9 μm and d90 from about 2.3 μm to about 2.9 μm. In some embodiments, a stable composition can have a mean particle size of about 1.3 μm to about 2.3 μm after being stored for 4 days at about 4.4° C. (about 40° F.). In some embodiments, a stable composition can have a mean particle size at day 0 and a mean particle size at 4 weeks that differs (+) by no more than about 25% (e.g., no more than about 20%, no more than about 18%) after being stored at about 21.1° C. (about 70° F.) for 4 weeks.

In some embodiments, the stability of the o/w emulsion can be measured by its zeta potential. In general, the higher the zeta potential, the more stable an emulsion, i.e., the particles have a higher resistance to aggregation. In some embodiments, the composition can have a zeta potential from about −5 mV to about −35 mV. For example, the zeta potential can range from about −5 mV or more (e.g., about −6 mV or more, about −8 mV or more, about −10 mV or more, about −12 mV or more, about −14 mV or more, about −16 mV or more, about −18 mV or more, about −20 mV or more, about −22 mV or more, about −24 mV or more, about −26 mV or more, about −28 mV or more, about −30 mV or more, about −32 mV or more, or about −34 mV or more) to about −35 mV or less (e.g., about −34 mV or less, about −32 mV or less, about −30 mV or less, about −28 mV or less, about −26 mV or less, about −24 mV or less, about −22 mV or less, about −20 mV or less, about −18 mV or less, about −16 mV or less, about −14 mV or less, about −12 mV or less, about −10 mV or less, about −9 mV or less, about −8 mV or less, about −7 mV or less, or about −6 mV or less).

In some embodiments, a stable composition can have a zeta potential from about −14 mV to about −21 mV after being stored for 4 days at about 4.4° C. (about 40° F.). In some embodiments, a stable composition can have a zeta potential at day 0 and a zeta potential at 4 weeks that differs (+) by no more than about 30% (e.g., no more than about 25%, no more than about 20%) after being stored at about 21.1° C. (about 70° F.) for 4 weeks.

Creaming occurs when particles aggregate and float to the top of the composition. Sedimentation occurs when those particle aggregates sink because of gravity. In some embodiments, the stability of the o/w emulsion can be measured by the sedimentation level. In some embodiments, a stable composition can have a sedimentation level at day 0 and a sedimentation level at 10 weeks that differs (±) by no more than about 2% (e.g. no more than about 1.5%, no more than about 1%) after being stored at about 21.1° C. (e.g., about 70° F.) for 10 weeks. In some embodiments, a stable composition can have a sedimentation level at day 0 and a sedimentation level at 24 weeks that differs (±) by no more than about 5% (e.g., about no more than about 4%, no more than about 3%, no more than about 2%, or no more than about 1%) after being stored at about 21.1° C. (about 70° F.) for 24 weeks.

According to any of the embodiments described herein, the composition is a ready-to-drink beverage. To ensure the composition in the RTD beverage is stable, in some embodiments, the ready-to-drink beverage is stored at a temperature less than about 32° C. (about 90° F.), including at about room temperature (e.g., about 21.1° C. (about 70° F.)) or refrigerated (e.g., about 4.4° C. (about 40° F.)). When stored at these temperatures, in some embodiments, the ready-to-drink beverage is stable (e.g., does not separate or curdle or increase in sediment) for at least 4 days (e.g., at least 1 week, at least 2 weeks, at least 3 weeks, at least 4 weeks, at least 5 weeks, at least 6 weeks, at least 8 weeks, at least 10 weeks, at least 12 weeks, at least 14 weeks, at least 16 weeks, at least 18 weeks, at least 20 weeks, at least 22 weeks, or at least 24 weeks).

In some embodiments, the ready-to-drink beverage can comprise, consist essentially of, or consist of pectin (e.g., high methoxyl pectin), gellan gum (e.g., high acyl gellan gum), coconut cream, water, and optionally one or more additives selected from the group consisting of green coffee bean extract, white coffee extract, at least one fruit juice concentrate, at least one acidulant (e.g., citric acid, ascorbic acid, malic acid, or a combination thereof), a sweetener (e.g., sucrose), and at least one flavoring agent. In some embodiments, a ready-to-drink beverage can comprise, consist essentially of, or consist of high methoxyl pectin, high acyl gellan gum, coconut cream, water, at least one fruit juice concentrate, citric acid, ascorbic acid, malic acid, sucrose, and at least one flavoring agent.

The present disclosure further relates to a method of preparing the composition. In some embodiments, the method can comprise:
combining the two or more hydrocolloid gums, the coconut-based fatty component (e.g., coconut cream), and water to form a first mixture;
blending the first mixture to provide a homogenous first mixture;
adding additional water to the homogenous first mixture to provide a second mixture; and
blending the second mixture to provide a homogenous second mixture.

It was surprisingly discovered that two separate blending steps (e.g., to provide the first and second homogenous mixtures) increased the stability of the emulsion, e.g., an emulsion with the desired particle size, particle size distribution, and zeta potential and that did not separate or curdle upon standing, particularly over time. The composition had reduced stability when only one of the blending (e.g., homogenizing) steps was used.

In some embodiments of the method, the two or more hydrocolloid gums can be combined at a first temperature before combining with the coconut-based fatty component and water. The combining step can be at any suitable temperature (e.g., a temperature that does not hydrolyze the hydrocolloid gums). In some embodiments, the two or more hydrocolloid gums can be combined at about 21° C. to about 74° C. (about 70-165° F.).

The mixing time is not particularly limited, but in some embodiments, the two or more hydrocolloid gums can be combined to form a slurry for a time period that ranges from about 5 min to about 60 min (e.g., about 10-45 min, about 10-40 min, about 10-35 min, or about 10-30 min).

In other embodiments, a first hydrocolloid gum is added first, and a second (and optional third) hydrocolloid gum is added with the coconut-based fatty component at a second temperature. In other embodiments, the two or more hydrocolloid gums and coconut-based fatty component are combined altogether under the same conditions.

In some embodiments of the method, the coconut-based fatty component (e.g., coconut cream) can be combined with the combined two or more hydrocolloid gums before combining with the water. In some embodiments, the coconut-based fatty component (e.g., coconut cream) can be added to the combined two or more hydrocolloid gums at about 18° C. to about 60° C. (about 65-140° F.). In some embodiments, the temperature range is about 24-55° C., about 27-50° C., or about 27-38° C.

Again, the mixing time is not particularly limited, but in some embodiments, the coconut-based fatty component can be combined with the two or more hydrocolloid gums to form a slurry for a time period that ranges from about 1 min to about 30 min (e.g., about 1-25 min, about 2-20 min, about 2-15 min, about 2-10 min, or about 1-5 min).

Blending (e.g., homogenizing) the first mixture to provide a homogenous first mixture can be at any suitable temperature and pressure. In some embodiments, the temperature should be set to a value that does not hydrolyze the hydrocolloid gums (e.g., pectin). In some embodiments, the temperature can range from about 32° C. to about 50° C. (about 90-120° F.). In some embodiments, the pressure can be 0 kPa. In other embodiments, the pressure can range from about 20,700 kPa to about 25,500 kPa (about 3000-3700 psi).

In some embodiments, the method can further comprise cooling the homogenous first mixture before adding the additional water.

In some embodiments of the method, the water is combined last along with any optional additives. In some embodiments, one or more additives are added and are selected from the group consisting of at least one fruit juice concentrate, at least one acidulant (e.g., citric acid, ascorbic acid, malic acid, or a combination thereof), a sweetener (e.g., sucrose), and at least one flavoring agent. In some embodiments, at least one fruit juice concentrate, citric acid, ascorbic acid, malic acid, sucrose, and at least one flavoring agent are added. In some embodiments, a sweetener (e.g., sucrose) is added after the two or more hydrocolloid gums are added and before the coconut-based fatty component is added.

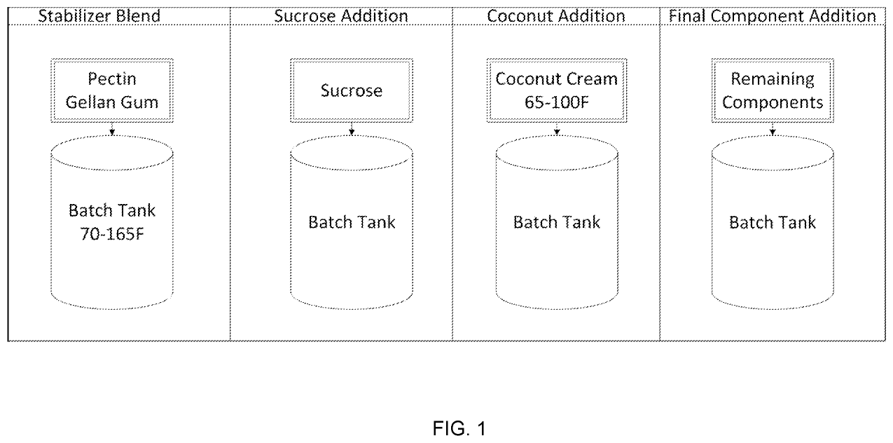

An illustrative example of the batch process is set forth in FIG. 1.

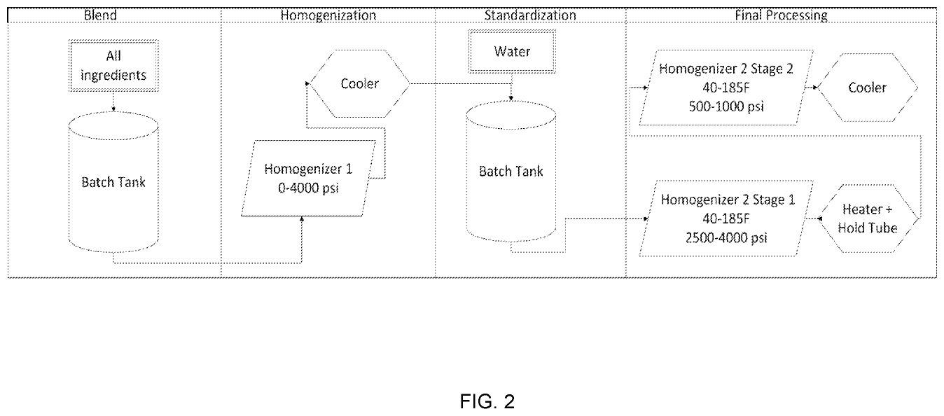

An illustrative example of the general process is set forth in FIG. 2.

At this point, the batch tank can be maintained at any suitable temperature. For example, the temperature can be about 4.4° C. to about 55° C. (about 40-131° F.), about 7.2° C. to about 49° C. (about 45-120° F.), or 10° C. to about 42° C. (about 50-108° F.).

Blending (e.g., homogenizing) the second mixture to provide a homogenous second mixture can be at any suitable temperature and pressure. In some embodiments, the temperature can range from about 50° C. to about 93° C. (about 122-200° F.), such as about 54° C. to about 85° C. or about 54° C. to about 66° C. In some embodiments, the pressure can range from about 17,000 kPa to about 27,000 kPa (about 2500-3900 psi). In some embodiments, the pressure can be about 20,700 kPa (about 3000 psi), about 25,000 kPa (about 3600 psi), or about 27,000 kPa (about 3900 psi).

In some embodiments of the method, blending (e.g., homogenizing) the second mixture to provide a homogenous second mixture can take place in two stages. In some embodiment, after the first stage and before the stage, the method can comprise a pasteurizing step. The pasteurizing step can comprise heating to a temperature that is about 100° C. or less. In an example, at least a portion of the composition is provided in a holding tube at a fixed volume for a set period of time for the pasteurization step. The set period of time can be any suitable time required to pasteurize the volume in the holding tube. For example, the pasteurizing step can be on the order of second, including a range of about 2 sec to about 60 sec (e.g., about 2 sec to about 45 sec, about 2 sec to about 30 sec, about 2 sec to about 20 sec, about 2 sec to about 15 sec, about 2 sec to about 10 sec, or about 2 sec to about 5 sec).

In some embodiments, the first stage of the second blending step can be at a higher pressure than the second stage. For example, the first stage can take place at a pressure of about 17,000 kPa to about 27,600 kPa (about 2500-4000 psi). The second stage can take place at a pressure of about 3400 kPa to about 6900 kPa (about 500-1000 psi). The temperature of the first and second stages can be within a range of about 4.4° C. to about 85° C. (about 40-185° F.).

In some embodiments of the method, the homogenous second mixture can be cooled after blending.

The present disclosure is further illustrated by the following embodiments.

(1) A composition comprising two or more hydrocolloid gums; a coconut-based fatty component; and water; wherein the composition has a pH less than 7 and is an oil-in-water emulsion.

(2) The composition of (1), wherein the two or more hydrocolloid gums are selected from the group consisting of a plant-based gum, an animal-derived gum, a microbial gum, a seaweed gum, a chemically modified gum, and combinations thereof.

(3) The composition of (1) or (2), wherein at least one of the two or more hydrocolloid gums is a plant-based gum selected from the group consisting of pectin, sunflower lecithin, guar gum, locust bean gum, tara gum, tamarind gum, linseed gum, gum acacia, karaya gum, tragacanth gum, konjac gum, aloe vera extract, inulin, xanax polysaccharide, and combinations thereof.

(4) The composition of any one of (1)-(3), wherein at least one of the two or more hydrocolloid gums is an animal-derived gum selected from the group consisting of gelatin, casein, sodium caseinate, chitin, chitosan, whey protein isolate, whey protein concentrate, collagen, and combinations thereof.

(5) The composition of any one of (1)-(4), wherein at least one of the two or more hydrocolloid gums is a microbial gum selected from the group consisting of xanthan gum, gellan gum, coagulated polysaccharide, yeast polysaccharide, and combinations thereof.

(6) The composition of any one of (1)-(5), wherein at least one of the two or more hydrocolloid gums is a seaweed gum selected from the group consisting of agar, carrageenan, an alginate, and combinations thereof.

(7) The composition of any one of (1)-(6), wherein at least one of the two or more hydrocolloid gums is a chemically modified gum selected from the group consisting of a cellulose gum, modified starch, sodium polyacrylate, polyvinylpyrrolidone, and combinations thereof.

(8) The composition of any one of (1)-(7), wherein at least one of the two or more hydrocolloid gums is pectin.

(9) The composition of (8), wherein the pectin comprises high methoxyl pectin.

(10) The composition of any one of (1)-(9), wherein at least one of the two or more hydrocolloid gums is gellan gum.

(11) The composition of (10), wherein the gellan gum comprises high acyl gellan gum.

(12) The composition of any one of (1)-(11), wherein the composition comprises two hydrocolloid gums in a weight ratio of about 0.25:1 to about 10:1.

(13) The composition of (12), wherein the composition comprises high methoxyl pectin and high acyl gellan gum in a weight ratio of about 3:1 to about 5:1.

(14) The composition of any one of (1)-(13), wherein the coconut-based fatty component is coconut cream, coconut milk, coconut milk powder, creamed coconut, coconut oil, or a combination thereof.

(15) The composition of (14), wherein the coconut-based fatty component is coconut cream.

(16) The composition of any one of (1)-(15), wherein the pH is less than about 5. (17) The composition of any one of (1)-(16), wherein the pH is about 4 or less.

(18) The composition of any one of (1)-(17), wherein the pH is about 3 or more.

(19) The composition of any one of (1)-(18) further comprising at least one additive.

(20) The composition of (19), wherein the at least one additive is selected from the group consisting of green coffee bean extract, white coffee extract, a fruit juice, an acidulant, a pH buffer, a sweetener, a preservative, an antioxidant, a flavoring agent, caffeine, and combinations thereof.

(21) The composition of any one of (1)-(20) further comprising green coffee bean extract, white coffee extract, or a combination of both.

(22) The composition of (21), wherein the fruit juice is white grape juice, strawberry juice, pineapple juice, acai juice, mango juice, dragon fruit juice, starfruit juice, kiwi juice, apple juice, orange juice, pear juice, blueberry juice, blackberry juice, raspberry juice, passionfruit juice, pomegranate juice, watermelon juice, cranberry juice, carrot juice, lemon juice, or a combination thereof.

(23) The composition of any one of (20)-(22), wherein the acidulant comprises at least one organic acid.

(24) The composition of (23), wherein the at least one organic acid is citric acid, malic acid, ascorbic acid, fumaric acid, tannic acid, or a combination thereof.

(25) The composition of any one of (20)-(24), wherein the pH buffer is a citrate buffer, a phosphate buffer, or a combination thereof.

(26) The composition of any one of (20)-(25), wherein the sweetener is a nutritive sweetener.

(27) The composition of any one of (20)-(26), wherein the preservative is sodium benzoate, potassium benzoate, potassium sorbate, calcium disodium edetate, or a combination thereof.

(28) The composition of any one of (20)-(27), wherein the antioxidant is ascorbic acid, a tocopherol, or a combination thereof.

(29) The composition of any one of (20)-(28), wherein the flavoring is strawberry flavoring agent, pineapple flavoring agent, acai flavoring agent, passionfruit flavoring agent, or a combination thereof.

(30) The composition of any one of (1)-(29), wherein the composition has a mean particle size of about 0.3 μm to about 3 μm.

(31) The composition of any one of (1)-(30), wherein the composition has a mean particle size of about 1.5 μm to about 1.9 μm and d90 from about 2.3 μm to about 2.9 μm.

(32) The composition of any one of (1)-(31), wherein the composition has a mean particle size of about 1.3 μm to about 2.3 μm after being stored for 4 days at about 4.4° C. (about 40° F.).

(33) The composition of any one of (1)-(32), wherein a mean particle size of the composition at day 0 and a mean particle size of the composition at 4 weeks differs by no more than about 25% after being stored at about 21.1° C. (about 70° F.) for 4 weeks.

(34) The composition of any one of (1)-(33), wherein the composition has a pH of about 3.1 to about 3.35 after being stored for 4 days at about 4.4° C. (about 40° F.).

(35) The composition of any one of (1)-(34), wherein the composition has a zeta potential from about −5 mV to about −35 mV.

(36) The composition of any one of (1)-(35), wherein the composition has a zeta potential from about −14 mV to about −21 mV after being stored for 4 days at about 4.4° C. (about 40° F.).

(37) The composition of any one of (1)-(36), wherein a zeta potential of the composition at day 0 and a zeta potential of the composition at 4 weeks differs by no more than about 30% after being stored at about 21.1° C. (about 70° F.) for 4 weeks.

(38) The composition of any one of (1)-(37), wherein a sedimentation level of the composition at day 0 and a sedimentation level of the composition at 10 weeks differs by no more than about 2% after being stored at about 21.1° C. (about 70° F.) for 10 weeks.

(39) The composition of any one of (1)-(38), wherein a sedimentation level of the composition at day 0 and a sedimentation level of the composition at 24 weeks differs by no more than about 5% after being stored at about 21.1° C. (about 70° F.) for 24 weeks.

(40) The composition of any one of (1)-(39), wherein the composition is a ready-to-drink beverage.

(41) A method of preparing the composition of any one of (1)-(40) comprising: combining the two or more hydrocolloid gums, the coconut-based fatty component, and water to form a first mixture;
blending the first mixture to provide a homogenous first mixture;
adding additional water to the homogenous first mixture to provide a second mixture; and
blending the second mixture to provide a homogenous second mixture.

(42) The method of (41) further comprising cooling the homogenous first mixture before adding the additional water.

(43) The method of (41) or (42), wherein blending the second mixture to provide a homogenous second mixture takes place in two stages with a pasteurizing step in between the two stages.

(44) The method of any one of (41)-(43), wherein the homogenous second mixture

(45) The method of any one of (41)-(44), wherein the two or more hydrocolloid gums are combined first before combining with the coconut-based fatty component and water.

(46) The method of (45), wherein the two or more hydrocolloid gums are combined at about 21° C. to about 74° C. (about 70° F. to about 165° F.). is cooled after blending.

(47) The method of (45) or (46), wherein the coconut-based fatty component is combined with the combined two or more hydrocolloid gums before combining with the water.

(48) The method of (47), wherein the coconut-based fatty component is combined with the combined two or more hydrocolloid gums at about 18° C. to about 60° C. (about 65° F. to about 140° F.).

(49) The method of any one of (45)-(48), wherein the water is combined last along with any optional additives.

### EXAMPLES

The example presented below is provided for the purpose of illustration only and the embodiments described herein should in no way be construed as being limited to this example. Rather, the embodiments should be construed to encompass any and all variations which become evident as a result of the teaching provided herein.

### Example 1

Compositions were prepared comprising two or more hydrocolloid gums, coconut cream (about 2.3 wt %), and water (added in an amount sufficient to provide 100 wt %). The compositions contained additives, that are optional: fruit juice concentrates (about 1.7 wt %), citric acid (about 0.1 wt %), ascorbic acid (about 0.03 wt %), malic acid (about 0.01 wt %), flavoring agents (about 0.7 wt %), natural colors, (about 0.02 wt %), decaffeinated green coffee extract (about 0.02 wt %), and sucrose (about 5.5 wt %). The formulations can alternatively be made with different additives, such as caffeinated green coffee extract, white coffee extract (caffeinated or decaffeinated), or a combination of any of these. The types and amounts of hydrocolloid gums are set forth in Table 1.

TABLE 1

| | Hydrocolloid Gum (wt %) | | | | | | | | |
|---|---|---|---|---|---|---|---|---|---|
| | | | | | High | Gum | | | |
| | Gellan | Gellan | Gellan | Gellan | Methoxyl | Arabic | | | High |
| | gum | gum | gum HM | gum | Citrus | Spray | Sunflower | Xanthan | Methoxyl |
| Cmpsn | HA-B^{a} | HF-B^{a} | pure^{a} | HM-B^{a} | Pectin^{b} | dry^{c} | Lecithin^{d} | gum | Pectin^{e} |
| 1 | 0.05 | | | | 0.45 | | | | |
| 2 | 0.75 | | | | 0.4 | | | | |
| 3 | 0.1 | | | | 0.35 | | | | |
| 4 | | 0.03 | | | 0.39 | | | | |
| 5 | | 0.04 | | | 0.35 | | | | |
| 6 | | | 0.03 | | 0.35 | | | | |
| 7 | | | | | 0.5 | | | | |
| 8 | | | | | 0.2 | 0.2 | | | |
| 9 | | | | | 0.35 | | | | |
| 10 | | | | 0.03 | 0.35 | | | | |
| 11 | | | | 0.04 | 0.35 | | | | |
| 12 | | | | 0.06 | 0.35 | | | | |
| 13 | | | | 0.1 | 0.35 | | | | |
| 14 | | | | 0.05 | 0.45 | | | | |
| 15 | | | | 0.07 | 0.45 | | | | |
| 16 | | | | 0.08 | 0.34 | | | | |
| 17 | | | | 0.08 | 0.35 | | 0.2 | | |
| 18 | | | | 0.08 | 0.35 | 0.2 | | | |
| 19 | | | | | 0.35 | | | 0.1 | |
| 20 | | | | 0.09 | 0.37 | | | | |
| 21 | | | | 0.09 | 0.3 | | | | |
| 22 | | | | 0.09 | 0.55 | | | | |
| 23 | | | | 0.08 | 0.45 | | | | |
| 24 | | | | 0.08 | 0.33 | | | | |
| 25 | | | | 0.08 | 0.35 | | | | |
| 26 | | | | 0.05 | | | | | 0.45 |
| 27 | | | | 0.09 | | | | | 0.35 |
| 28 | | | 0.03 | | | | | | 0.35 |
| 29 | | 0.04 | | | | | | | 0.35 |

^{a}KELCOGEL ™ (CP Kelco, Atlanta, GA)
^{b}GRINDSTED AMD (Danisco, Denmark)
^{c}TIC PRETESTED ™ (TIC GUMS, White Marsh, MD)
^{d}SOLEC ™ SF 10 (SOLAE, St. Louis, MO)
^{e}SLENDID ™ type 200 (CP Kelco, Atlanta, GA)

### Example 2

Exemplary compositions from Table 1 were prepared in accordance with the processes in FIGS. 1 and 2. The processing conditions for Trials A-P are set forth in Table 2. Rheological properties for the emulsions were calculated for exemplary trials over time (e.g., 0 days, 9 days, 14 days, and >4 weeks) at various temperatures (e.g., 40° F., 70° F., 90° F., and 110° F.). The mean particle size (MPS) (μm) and d90 (μm) values are set forth in Tables 3-6. The zeta potentials (mV) for are set forth in Table 7. The pH values are set forth in Table 8.

TABLE 2

| | | Hydrocolloid | | Coconut | | | | | | |
|---|---|---|---|---|---|---|---|---|---|---|
| | | Gum Slurry | | Cream Slurry | | Homogenization 1 | | Final | Homogenization 2 | |
| | | | dispersion | | dispersion | | Total | Batch | | Total |
| | | Temp | time | Temp | time | Temp | pressure | Temp | Temp | pressure |
| Trial | Test | (° F.) | (min) | (° F.) | (min) | (° F.) | (psi) | (° F.) | (° F.) | (psi) |
| A | 24, 25 | 129-133 | 10-11 | 127-131 | 5 | N/A | N/A | 113-117 | 130-131 | 3000 |
| B | 16 | 126-133 | 13 | 130 | 5 | N/A | N/A | 115-117 | 128-133 | 3000 |
| C | 16 | 124 | 12-15 | 124 | 2-5 | N/A | N/A | 108-113 | ~165-75 | 3600 |
| D | 16 | 120 | 23 | 130 | 10 | N/A | N/A | 103 | ~155-165 | 3600 |
| E | 20 | 124-125 | 16-17 | 100 | 2 | N/A | N/A | 125 | 185 | 3600 |
| F | 16, 20 | 120 | 35 | 120 | 5 | N/A | N/A | ~100 | 130-180 | 2500-3500 |
| G | 20 | 147.2 | 18 | 100 | 2 | N/A | N/A | 116 | 170-175 | 3900 |
| H | 20 | 154-158 | 20-22 | 100 | 2 | N/A | N/A | 116 | 170-175 | 3900 |
| I | 20 | 117 | 18 | 100 | 2 | N/A | N/A | 54 | 134-149 | 3900 |
| J | 16 | 116 | 29 | 80 | 2 | N/A | N/A | 49 | 132-152 | 3900 |
| K | 22 | 114 | 17 | 75 | 2 | N/A | N/A | 46 | 132-141 | 3900 |
| L | 16 | 116 | 29 | 80 | 2 | 110 | 3500 | 46 | 132-141 | 3900 |
| M | 21 | 113 | 19 | 80 | 5 | 105 | 3250 | 42-46 | 132-143 | 3900 |
| N | 16 | 112 | 23 | 76-81 | 5 | 106 | 3250 | 43 | 132-142 | 3900 |
| O | 16 | 112-117 | 16 | 80 | 5 | 106 | 3250 | 42-43 | 132-143 | 3900 |
| P | 16 | 114-118 | 22 | 80 | 5 | 106 | 3250 | 46 | 132-143 | 3900 |

TABLE 3

Day 0
70° F.

| Trial | MPS | d90 |
|---|---|---|
| C | 1.87 | 3.11 |
| E | 1.54 | 2.51 |
| H | 1.678 | 2.602 |
| I | 2.017 | 3.037 |
| J | 1.409 | 2.263 |
| K | 1.808 | 2.907 |
| L | 1.47 | 2.335 |
| M | 1.695 | 2.541 |
| N | 1.167 | 2.127 |
| O | 1.193 | 2.129 |
| P | 1.63 | 2.472 |

TABLE 4

| | Day 9 | | | | | | | |
|---|---|---|---|---|---|---|---|---|
| | 40° F. | | 70° F. | | 90° F. | | 110° F. | |
| Trial | MPS | d90 | MPS | d90 | MPS | d90 | MPS | d90 |
| C | 1.41 | 2.47 | 1.39 | 2.46 | 1.8 | 3.26 | 3.61 | 7.19 |
| E | 1.64 | 2.63 | 1.67 | 2.64 | 1.74 | 2.82 | 1.86 | 3.04 |
| H | 1.642 | 2.555 | 1.677 | 2.577 | 1.876 | 2.982 | 2.705 | 5.105 |
| J | 1.524 | 2.508 | 1.489 | 2.426 | 1.677 | 2.789 | 1.647 | 2.727 |
| K | 1.696 | 2.745 | 1.674 | 2.645 | 2.164 | 3.828 | 3.523 | 5.942 |
| L | 1.628 | 2.709 | 1.541 | 2.507 | 1.657 | 2.765 | 1.743 | 2.946 |
| M | — | — | 1.937 | 2.86 | 2.201 | 3.546 | 2.718 | 4.434 |
| N | — | — | 1.895 | 2.923 | 2.172 | 3.604 | 3.279 | 5.234 |
| O | — | — | 1.873 | 2.821 | 2.112 | 3.336 | 2.992 | 4.835 |
| P | 1.892 | 2.834 | 1.915 | 2.867 | 2.204 | 3.657 | 2.746 | 4.353 |

TABLE 5

| | Day 14 | | | | | | | |
|---|---|---|---|---|---|---|---|---|
| | 40° F. | | 70° F. | | 90° F. | | 110° F. | |
| Trial | MPS | d90 | MPS | d90 | MPS | d90 | MPS | d90 |
| M | 1.925 | 2.843 | 2.017 | 3.054 | 2.192 | 3.479 | 2.959 | 4.899 |
| N | 1.779 | 2.73 | 1.889 | 2.963 | 2.422 | 4.124 | 3.622 | 5.571 |
| O | 1.815 | 2.739 | 1.969 | 3.056 | 2.176 | 3.52 | 3.384 | 5.503 |
| P | 1.904 | 2.87 | 1.918 | 2.871 | 2.141 | 3.373 | 3.145 | 5.052 |

TABLE 6

| >4 weeks | | |
|---|---|---|
| 70° F. | 90° F. | 110° F. |

| Trial | MPS | d90 | MPS | d90 | MPS | d90 |
|---|---|---|---|---|---|---|
| M | 1.899 | 2.898 | 2.372 | 4.043 | 2.891 | 4.717 |
| N | 1.94 | 3.12 | 2.944 | 4.676 | 6.219 | 10.529 |
| O | 1.912 | 2.89 | 3.406 | 6.294 | 4.711 | 8.232 |
| P | 1.926 | 2.947 | 2.155 | 3.464 | 2.715 | 4.342 |

TABLE 7

| | Zeta Potential (mV) | | | | | | | | | | | |
|---|---|---|---|---|---|---|---|---|---|---|---|---|
| | Day 0 | Day 9 | | | | Day 14 | | | | >4 weeks | | |
| Trial | 70° F. | 40° F. | 70° F. | 90° F. | 110° F. | 40° F. | 70° F. | 90° F. | 110° F. | 70° F. | 90° F. | 110° F. |
| H | −20.5 | −20.4 | −21 | −19.9 | −18.1 | | | | | | | |
| I | −22.5 | | | | | | | | | | | |
| J | −18.9 | 12.5 | −12.1 | −11.7 | −11.2 | −13.1 | −13 | −12.1 | −12 | | | |
| K | −20.2 | −15.7 | −19.7 | −21.7 | −18.1 | −21 | −21.3 | −22.6 | −18.4 | | | |
| L | −20.2 | −13.3 | −13.4 | −11.4 | −10.9 | −13.6 | −13.4 | −11.7 | −12.1 | | | |
| M | −18.9 | | −18.6 | −15.9 | −12.5 | −16.1 | −18.5 | −16.5 | −12.8 | −18.5 | −14.9 | −14.5 |
| N | −23.8 | | −19.1 | −17.4 | −12.6 | −19.3 | −18.9 | −16 | −12.1 | −13.9 | −10.1 | −13.4 |
| O | −17.6 | | −19.1 | −17.9 | −13.5 | −19 | −19.9 | −17.6 | −13.9 | −19.6 | −15.8 | −14.9 |
| P | −19.5 | | −19.8 | −19.2 | −14.6 | −20 | −19.8 | −18 | −15.2 | −20 | −17 | −16.7 |

| | TRIAL 8 | | | | | | | | | | | |
|---|---|---|---|---|---|---|---|---|---|---|---|---|
| | pH | | | | | | | | | | | |
| | Day 0 | Day 9 | | | | Day 14 | | | | >4 weeks | | |
| Trial | 70° F. | 40° F. | 70° F. | 90° F. | 110° F. | 40° F. | 70° F. | 90° F. | 110° F. | 70° F. | 90° F. | 110° F. |
| H | 3.36 | 3.27 | 3.23 | 3.21 | 3.17 | | | | | | | |
| I | 3.26 | | | | | | | | | | | |
| J | 3.09 | 3.25 | 3.17 | 3.14 | 3.11 | 3.1 | 3.12 | 3.11 | 3.11 | | | |
| K | 3.2 | 3.25 | 3.2 | 3.16 | 3.13 | 3.13 | 3.12 | 3.1 | 3.09 | | | |
| L | 3.21 | 3.26 | 3.21 | 3.16 | 3.14 | 3.17 | 3.14 | 3.16 | 3.14 | | | |
| M | 3.16 | | 3.08 | 3.11 | 3.08 | 3.2 | 3.08 | 3.07 | 3.07 | 3.18 | 3.13 | 3.13 |
| N | 3.19 | | 3.06 | 3.02 | 3.02 | 3.15 | 3.09 | 3.1 | 3.11 | 3.12 | 3.12 | 3.08 |
| O | 3.17 | | 3.11 | 3.07 | 3.06 | 3.18 | 3.13 | 3.13 | 3.1 | 3.16 | 3.1 | 3.11 |
| P | 3.13 | | 3.07 | 3.05 | 3.07 | 3.2 | 3.11 | 3.12 | 3.1 | 3.14 | 3.15 | 3.1 |

### Example 3

Exemplary compositions from Table 1 were prepared in accordance with the processes in FIGS. 1 and 2. The effect of the parameters of the second homogenizing step on emulsion stability are set forth in Table 9. A GEA Lab Homogenizer NS2002H was used (GEA, Columbia, MD).

TABLE 9

| | | | | mean particle size (μm) | | | pH | | | Zeta potential | | |
|---|---|---|---|---|---|---|---|---|---|---|---|---|
| | | Homogenization | | Day 1 | Day 4 | Day 4 | Day 1 | Day 4 | Day 4 | Day 1 | Day 4 | Day 4 |
| Entry | Cmpsn | ° F. | psi | 40° F. | 40° F. | 110° F. | 40° F. | 40° F. | 110° F. | 40° F. | 40° F. | 110° F. |
| 1 | 20 | 130 | 2500 | 1.93 | 2.01 | 2.298 | 3.27 | 3.25 | 3.14 | −18.3 | −14.45 | −11.1 |
| 2 | 20 | 130 | 3500 | 1.66 | 1.8 | 2 | 3.32 | 3.25 | 3.14 | −17 | −16.1 | −14.8 |
| 3 | 20 | 180 | 2500 | 1.66 | 1.74 | 2.06 | 3.35 | 3.28 | 3.14 | −17.5 | −18.3 | −14.53 |
| 4 | 20 | 180 | 3500 | 1.35 | 1.374 | 1.71 | 3.35 | 3.31 | 3.14 | −18.9 | −19.7 | −16.4 |
| 5 | 16 | 130 | 2500 | 2.1 | 2.255 | 2.738 | 3.31 | 3.25 | 3.09 | −14.7 | −19.9 | −15.5 |
| 6 | 16 | 130 | 3500 | 1.68 | 1.897 | 2.183 | 3.32 | 3.2 | 3.14 | −17.5 | −20.7 | −16 |
| 7 | 16 | 180 | 2500 | 1.67 | 2.1 | 2.286 | 3.29 | 3.21 | 3.17 | −14.2 | −17.3 | −17 |
| 8 | 16 | 180 | 3500 | 1.64 | 1.7 | 1.82 | 3.32 | 3.16 | 3.17 | −15.95 | −19.4 | −15 |

### Example 4

The stabilities of compositions from exemplary trials in Table 2 were measured over time as a function of temperature, as indicated by the pH, solids content, density (g/mL), and specific gravity (SG) (kg/m³) values. The density and SG were measured using a density meter (DMA 4500M) (Anton Paar, Austria). Table 10 is directed to the composition of Trial A. Table 11 is directed to the composition of Trial C. Table 12 is directed to the composition of Trial J.

TABLE 10
70° F. samples

| Weeks | pH | Solids | Density | SG |
|---|---|---|---|---|
| 4 | 3.08 | 8.37 | 1.03 | 1.03 |
| 6 | 3.1 | 8.31 | 1.03 | 1.03 |
| 8 | 3.08 | 8.32 | 1.03 | 1.03 |
| 12 | 3.1 | 8.43 | 1.03 | 1.03 |
| 16 | 3.09 | 8.55 | 1.03 | 1.03 |
| 20 | 3.06 | 8.29 | 1.03 | 1.03 |
| 24 | 3.09 | 8.44 | 1.03 | 1.03 |
| 28 | 3.11 | 8.36 | 1.03 | 1.03 |
| 32 | 3.1 | 8.45 | 1.03 | 1.03 |

TABLE 11

| | | | | |
|---|---|---|---|---|
| Weeks | pH | Solids | Density | SG |

40° F. samples

| | | | | |
|---|---|---|---|---|
| 2 | 3.39 | 8.51 | 1.03 | 1.03 |
| 4 | 3.19 | 7.94 | 1.03 | 1.03 |
| 6 | 3.16 | 8.22 | 1.03 | 1.03 |
| 8 | 3.14 | 8.4 | 1.03 | 1.03 |
| 10 | 3.16 | 8.21 | 1.03 | 1.03 |
| 12 | 3.22 | 8.31 | 1.03 | 1.03 |
| 14 | 3.21 | 8.38 | 1.03 | 1.03 |
| 16 | 3.21 | 8.45 | 1.03 | 1.03 |
| 18 | 3.19 | 8.36 | 1.03 | 1.03 |
| 20 | 3.25 | 8.48 | 1.03 | 1.03 |
| 22 | 3.19 | 8.47 | 1.03 | 1.03 |

70° F. samples

| | | | | |
|---|---|---|---|---|
| 0 | 3.34 | 8.55 | 1.03 | 1.03 |
| 2 | 3.39 | 8.37 | 1.03 | 1.03 |
| 4 | 3.17 | 8.22 | 1.03 | 1.03 |
| 6 | 3.17 | 8.29 | 1.03 | 1.03 |
| 8 | 3.13 | 8.42 | 1.03 | 1.03 |
| 10 | 3.17 | 7.98 | 1.03 | 1.03 |
| 12 | 3.21 | 8.4 | 1.03 | 1.03 |
| 14 | 3.18 | 8.6 | 1.03 | 1.03 |
| 16 | 3.16 | 8.47 | 1.03 | 1.03 |
| 18 | 3.09 | 8.71 | 1.03 | 1.03 |
| 20 | 3.16 | 8.69 | 1.03 | 1.03 |
| 22 | 3.11 | 8.61 | 1.03 | 1.03 |

90° F. samples

| | | | | |
|---|---|---|---|---|
| 2 | 3.38 | 8.18 | 1.03 | 1.03 |
| 4 | 3.17 | 8.08 | 1.03 | 1.03 |
| 6 | 3.16 | 8.46 | 1.03 | 1.03 |
| 8 | 3.11 | 8.54 | 1.03 | 1.03 |
| 10 | 3.16 | 8.09 | 1.03 | 1.03 |
| 12 | 3.2 | 8.39 | 1.03 | 1.03 |
| 14 | 3.19 | 8.68 | 1.03 | 1.03 |
| 16 | 3.18 | 8.79 | 1.03 | 1.03 |

110° F. samples

| | | | | |
|---|---|---|---|---|
| 2 | 3.41 | 8.5 | 1.03 | 1.03 |
| 4 | 3.2 | 8.68 | 1.03 | 1.03 |
| 6 | 3.16 | 8.37 | 1.03 | 1.03 |
| 8 | 3.09 | 8.62 | 1.03 | 1.03 |
| 10 | 3.14 | 8.02 | 1.03 | 1.03 |
| 12 | 3.19 | 8.38 | 1.03 | 1.03 |

TABLE 12

| | | | | |
|---|---|---|---|---|
| Weeks | pH | Solids | Density | SG |

70° F. samples

| | | | | |
|---|---|---|---|---|
| 0 | 3.2 | 8.48 | 1.03 | 1.03 |
| 4 | 3.19 | 8.5 | 1.03 | 1.03 |
| 6 | 3.18 | 8.33 | 1.03 | 1.03 |
| 8 | 3.22 | 8.5 | 1.03 | 1.03 |
| 10 | 3.18 | 8.54 | 1.03 | 1.03 |

90° F. samples

| | | | | |
|---|---|---|---|---|
| 4 | 3.19 | 8.62 | 1.03 | 1.03 |
| 6 | 3.16 | 8.54 | 1.03 | 1.03 |
| 8 | 3.23 | 8.62 | 1.03 | 1.03 |
| 10 | 3.23 | 8.85 | 1.03 | 1.03 |

110° F. samples

| | | | | |
|---|---|---|---|---|
| 4 | 3.19 | 8.78 | 1.03 | 1.03 |
| 6 | 3.17 | 8.59 | 1.03 | 1.03 |
| 8 | 3.21 | 8.79 | 1.03 | 1.03 |
| 10 | 3.24 | 8.54 | 1.03 | 1.03 |

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

1. A composition comprising
two or more hydrocolloid gums;
a coconut-based fatty component; and
water;
wherein the composition has a pH less than 7 and is an oil-in-water emulsion.

2. (canceled)

3. The composition of claim 1, wherein at least one of the two or more hydrocolloid gums is a plant-based gum selected from the group consisting of pectin, sunflower lecithin, guar gum, locust bean gum, tara gum, tamarind gum, linseed gum, gum acacia, karaya gum, tragacanth gum, konjac gum, aloe vera extract, inulin, xanax polysaccharide, and combinations thereof.

4. The composition of claim 1, wherein at least one of the two or more hydrocolloid gums is an animal-derived gum selected from the group consisting of gelatin, casein, sodium caseinate, chitin, chitosan, whey protein isolate, whey protein concentrate, collagen, and combinations thereof.

5. The composition of claim 1, wherein at least one of the two or more hydrocolloid gums is a microbial gum selected from the group consisting of xanthan gum, gellan gum, coagulated polysaccharide, yeast polysaccharide, and combinations thereof.

6. The composition of claim 1, wherein at least one of the two or more hydrocolloid gums is a seaweed gum selected from the group consisting of agar, carrageenan, an alginate, and combinations thereof.

7. The composition of claim 1, wherein at least one of the two or more hydrocolloid gums is a chemically modified gum selected from the group consisting of a cellulose gum, modified starch, sodium polyacrylate, polyvinylpyrrolidone, and combinations thereof.

8. The composition of claim 1, wherein at least one of the two or more hydrocolloid gums is pectin.

9. (canceled)

10. The composition of claim 1, wherein at least one of the two or more hydrocolloid gums is gellan gum.

11. (canceled)

12. The composition of claim 1, wherein the composition comprises two hydrocolloid gums in a weight ratio of about 0.25:1 to about 10:1.

13. The composition of claim 12, wherein the composition comprises high methoxyl pectin and high acyl gellan gum in a weight ratio of about 3:1 to about 5:1.

14. The composition of claim 1, wherein the coconut-based fatty component is coconut cream, coconut milk, coconut milk powder, creamed coconut, coconut oil, or a combination thereof.

15. (canceled)

16. The composition of claim 1, wherein the pH is less than about 5.

17-18. (canceled)

19. The composition of further comprising at least one additive.

20. The composition of claim 19, wherein the at least one additive is selected from the group consisting of green coffee bean extract, white coffee extract, a fruit juice, an acidulant, a pH buffer, a sweetener, a preservative, an antioxidant, a flavoring agent, caffeine, and combinations thereof.

21. The composition of claim 1, further comprising green coffee bean extract, white coffee extract, or a combination of both.

22. The composition of claim 21, wherein the fruit juice is white grape juice, strawberry juice, pineapple juice, acai juice, mango juice, dragon fruit juice, starfruit juice, kiwi juice, apple juice, orange juice, pear juice, blueberry juice, blackberry juice, raspberry juice, passionfruit juice, pomegranate juice, watermelon juice, cranberry juice, carrot juice, lemon juice, or a combination thereof.

23. The composition of claim 20, wherein the acidulant comprises at least one organic acid.

24. The composition of claim 23, wherein the at least one organic acid is citric acid, malic acid, ascorbic acid, fumaric acid, tannic acid, or a combination thereof.

25. The composition of claim 20, wherein the pH buffer is a citrate buffer, a phosphate buffer, or a combination thereof.

26. The composition of claim 20, wherein the sweetener is a nutritive sweetener.

27. The composition of claim 20, wherein the preservative is sodium benzoate, potassium benzoate, potassium sorbate, calcium disodium edetate, or a combination thereof.

28. The composition of claim 20, wherein the antioxidant is ascorbic acid, a tocopherol, or a combination thereof.

29. The composition of claim 20, wherein the flavoring is strawberry flavoring agent, pineapple flavoring agent, acai flavoring agent, passionfruit flavoring agent, or a combination thereof.

30. The composition of claim 20, wherein the composition has a mean particle size of about 0.3 μm to about 3 μm.

31. (canceled)

32. The composition of claim 1, wherein the composition has a mean particle size of about 1.3 μm to about 2.3 μm after being stored for 4 days at about 4.4° C. (about 40° F.).

33. The composition of claim 1, wherein a mean particle size of the composition at day 0 and a mean particle size of the composition at 4 weeks differs by no more than about 25% after being stored at about 21.1° C. (about 70° F.) for 4 weeks.

34-35. (canceled)

36. The composition of claim 1, wherein the composition has a zeta potential from about −14 mV to about −21 mV after being stored for 4 days at about 4.4° C. (about 40° F.).

37. The composition of claim 1, wherein a zeta potential of the composition at day 0 and a zeta potential of the composition at 4 weeks differs by no more than about 30% after being stored at about 21.1° C. (about 70° F.) for 4 weeks.

38. The composition of claim 1, wherein a sedimentation level of the composition at day 0 and a sedimentation level of the composition at 10 weeks differs by no more than about 2% after being stored at about 21.1° C. (about 70° F.) for 10 weeks.

39. The composition of claim 1, wherein a sedimentation level of the composition at day 0 and a sedimentation level of the composition at 24 weeks differs by no more than about 5% after being stored at about 21.1° C. (about 70° F.) for 24 weeks.

40. (canceled)

41. A method of preparing the composition of claim 1, comprising:
combining the two or more hydrocolloid gums, the coconut-based fatty component, and water to form a first mixture;
blending the first mixture to provide a homogenous first mixture;
adding additional water to the homogenous first mixture to provide a second mixture; and
blending the second mixture to provide a homogenous second mixture.

42-49. (canceled)
